(19) United States
(12) Patent Application Publication
(10) Pub. No.: US 2020/0380442 A1
(43) Pub. Date: Dec. 3, 2020

(54) INFORMATION PROCESSING DEVICE, INFORMATION PROCESSING METHOD, AND NON-TRANSITORY STORAGE MEDIUM STORING INFORMATION PROCESSING PROGRAM

(71) Applicant: TOYOTA JIDOSHA KABUSHIKI KAISHA, Toyota-shi (JP)

(72) Inventor: Masahiro KUWAHARA, Kasukabe-shi (JP)

(73) Assignee: TOYOTA JIDOSHA KABUSHIKI KAISHA, Toyota-shi (JP)

(21) Appl. No.: 16/879,848

(22) Filed: May 21, 2020

(30) Foreign Application Priority Data
May 28, 2019 (JP) 2019-099626

(51) Int. Cl. G06Q 10/06; G06Q 50/30; G06F 16/9537

(52) U.S. Cl. CPC G06Q 10/06315; G06F 16/9537; G06Q 10/0639; G06Q 50/30

(57) ABSTRACT

An information processing device extracts a candidate driver who is a candidate for a driver who is able to share a vehicle with a rider based on ride-sharing condition information of the rider and usage tendency information which indicates a tendency in using ride-sharing of each user when he/she used the ride-sharing in the past. The information processing device inquires of the candidate driver regarding an intention to share his/her vehicle with the rider, and determines the driver who is to share his/her vehicle with the rider based on a response to the inquiry. The usage tendency information includes information on a response time when the users responded to the inquiry in the past. The information processing device extracts the candidate driver based on information on the response time included in the usage tendency information.

### CROSS-REFERENCE TO RELATED APPLICATION

This application claims priority to Japanese Patent Application No. 2019-099626 filed on May 28, 2019, incorporated herein by reference in its entirety.

### BACKGROUND

### 1. Technical Field

The present disclosure relates to an information processing device, an information processing method, and a non-transitory storage medium storing an information processing program.

### 2. Description of Related Art

Recently, for purposes of reducing traffic congestion, saving fuel costs, environmental measures, or the like, a form in which a plurality of users share the same vehicle and ride together (so-called ride-sharing) has been spreading throughout many countries. In particular, when more than a certain number of users share a single vehicle, some countries provide the ride-sharing users with benefits, such as permitting using dedicated lanes and freeing tolls, thereby encouraging a broad use of the ride-sharing.

As an example of a system that realizes the ride-sharing as above, a technology is proposed in which when a request is received from a user (a rider) who desires to share a vehicle driven by another user (a driver), a candidate driver who can share a vehicle with the rider is extracted based on a relative position between a pick-up location desired by the rider and a position of the driver who drives the vehicle (shared vehicle) that can be shared with the rider (see, for example, Japanese Unexamined Patent Application Publication No. 2019-500681).

### SUMMARY

However, when it is necessary to determine the driver who is to share the vehicle with the rider in a relatively short time, if the candidate driver is extracted based on the above relative position, it may not be possible to determine, by a pick-up time desired by the rider, a driver who is to share the vehicle with the rider. In other words, even when the candidate driver positioned in the vicinity of the pick-up location desired by the rider can be extracted, it is necessary to inquire of the candidate driver regarding an intention to share the vehicle with the rider. Therefore, when a response to the inquiry is not promptly obtained from the candidate driver, it becomes difficult to determine, by the pick-up time desired by the rider, a driver who is to share the vehicle with the rider.

The present disclosure provides a technology that can efficiently determine a driver who is to share a vehicle with a rider when a ride-sharing service is provided.

A first aspect of the present disclosure is an information processing device that determines a pairing between a driver who is a user driving a vehicle to be used for ride-sharing, and a rider who is another user, as a non-driver, desiring to share the vehicle with the driver, in a form in which a plurality of users share the same vehicle. The information processing device includes a storage unit configured to store usage tendency information which is information on a tendency in using the ride-sharing of each of the users, and a control unit configured to acquire ride-sharing condition information including a movement section and a movement time range desired by the rider, extract a candidate driver who is a candidate for a driver who has a possibility of sharing a vehicle with the rider based on the ride-sharing condition information and the usage tendency information, and inquire of the candidate driver regarding an intention to share the vehicle with the rider and determine the driver who is to share the vehicle with the rider based on a response to the inquiry. The usage tendency information includes information on a response time when the users responded to the inquiry in the past. The control unit is configured to extract the candidate driver using information on the response time.

In the first aspect, the control unit may calculate an evaluation value of each of the users based on the ride-sharing condition information and the usage tendency information and preferentially extract, as the candidate driver, a user having a high evaluation value over a user having a low evaluation value. The control unit may calculate the evaluation value in such a manner that a user having a short response time has a higher evaluation value than a user having a long response time.

In the first aspect, the usage tendency information may further include information on the number of times of using the ride-sharing by each of the users for each time range. The control unit may calculate the evaluation value in such a manner that a user having a greater number of times of using the ride-sharing during the movement time range desired by the rider obtains a higher evaluation value than a user having a smaller number of times of using the ride-sharing during the movement time range desired by the rider.

In the first aspect, the usage tendency information may further include information on an acceptance rate, which is a rate at which each of the users made a positive response to the inquiry in the past. The control unit may calculate the evaluation value in such a manner that a user having a high acceptance rate obtains a higher evaluation value than a user having a low acceptance rate.

A second aspect of the present disclosure is an information processing method that determines a pairing between a driver who is a user driving a vehicle to be used for ride-sharing, and a rider who is another user, as a non-driver, desiring to share the vehicle with the driver, in a form in which a plurality of users share the same vehicle, and that is executed by a computer including a storage unit configured to store usage tendency information which is information on a tendency in using the ride-sharing of each of the users. The information processing method includes a step of acquiring ride-sharing condition information including a movement section and a movement time range desired by the rider, a step of extracting a candidate driver who is a candidate for a driver who has a possibility of sharing a vehicle with the rider based on the ride-sharing condition information and the usage tendency information, and a step of inquiring of the candidate driver regarding an intention to share the vehicle with the rider and determining the driver who is to share the vehicle with the rider based on a response to the inquiry. In this case, the usage tendency information may include information on a response time when the user responded to the inquiry in the past. The computer may extract the candidate driver using information on the response time.

A third aspect of the present disclosure is a non-transitory storage medium storing an information processing program that determines a pairing between a driver who is a user driving a vehicle, and a rider who is another user, as a non-driver, desiring to share the vehicle with the driver, in a form in which a plurality of users share the same vehicle, and is executable by a computer including a storage unit configured to store usage tendency information which is information on a tendency in using the ride-sharing of each of the users. The information processing program causes the computer to perform functions comprising: acquiring ride-sharing condition information including a movement section and a movement time range desired by the rider, a step of extracting a candidate driver who is a candidate for a driver who has a possibility of sharing a vehicle with the rider based on the ride-sharing condition information and the usage tendency information; inquiring of a candidate driver regarding an intention to share a vehicle with the rider and determining the driver who is to share the vehicle with the rider based on a response to the inquiry, in which the usage tendency information including information on a response time when the users responded to the inquiry in the past; and extracting the candidate driver using information on the response time.

With each aspect of the present disclosure, a driver who is to share a vehicle with a rider can be efficiently determined when a ride-sharing service is provided.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a diagram illustrating an overview of ride-sharing;

FIG. 2 is a diagram illustrating one configuration example of a ride-sharing system;

FIG. 3 is a diagram illustrating a hardware configuration of a user terminal and a server device;

FIG. 4 is a block diagram illustrating a functional configuration of the server device;

FIG. 5 is a diagram illustrating a configuration example of a travel schedule information table;

FIG. 6 is a diagram illustrating a configuration example of a movement schedule information table;

FIG. 7 is a diagram illustrating a configuration example of a reservation information table;

FIG. 8 is a diagram illustrating another configuration example of the reservation information table;

FIG. 9 is a table illustrating a configuration example of a usage tendency information table;

FIG. 10 is a table illustrating one example of criteria of setting a first coefficient A₁;

FIG. 11 is a table illustrating one example of criteria of setting a second coefficient A₂;

FIG. 12 is a table illustrating one example of criteria of setting a third coefficient A₃; and

FIG. 13 is a flowchart illustrating a process (a re-matching process) executed in the server device in response to an occurrence of a re-matching request.

### DETAILED DESCRIPTION OF EMBODIMENTS

The present disclosure relates to an information processing device that executes a process (a matching process) for determining a pairing between a driver who drives a shared vehicle and a rider who, as a non-driver, desires to ride the shared vehicle with the driver in ride-sharing in which a plurality of users share the same vehicle.

After the completion of matching the driver with the rider, when the driver cancels the matching immediately before a pick-up time (a start time of a desired movement time range) desired by the rider, it is necessary to re-determine a new driver who is to share a vehicle with the rider. To handle the above situation, a method is conceivable in which a user positioned in the vicinity of the pick-up location (a starting point of a desired movement section) desired by the rider is extracted as a candidate driver, from among users who can drive shared vehicles.

However, when the candidate driver is extracted using the above method, it is necessary to inquire of the extracted candidate driver regarding an intention to share his/her vehicle with the rider and determine a driver who is to share the vehicle with the rider based on a response to the inquiry (whether a driver has an intention to share his/her vehicle with the rider). Thus, when the response to the above inquiry (hereinafter, also referred to as “confirmation of intention”) is not promptly obtained from the candidate driver, it becomes difficult to determine, by the pick-up time desired by the rider, a driver who is to share a vehicle with the rider. When such a situation occurs, user convenience, or the users' motivation to use a ride-sharing service is decreased, which may make it difficult for the ride-sharing to be widely used. In particular, when it is assumed that the ride-sharing is used for transportation when commuting, a situation may easily occur in which a time at which the driver or the rider leaves work is changed due to work or the like, and thus a driver who is to share a vehicle with the rider needs to be determined again in a short time. Therefore, it may be difficult to increase the number of users who commute using the ride-sharing. As a result, it may be difficult to reduce traffic congestion during commuting hours.

Therefore, the information processing device according to the present disclosure includes a storage unit that accumulates information (usage tendency information) on a tendency in using the ride-sharing of each user. In such an information processing device, the control unit extracts the candidate driver based on ride-sharing condition information including a movement section and a movement time range desired by the rider, and the usage tendency information. The usage tendency information includes information on a response time when each user responded to the confirmation of intention in the past. In addition, the control unit extracts the candidate driver in consideration of the response time included in the usage tendency information of each user. As such, when it is necessary to re-determine a new driver who is to share a vehicle with the rider in a relatively short time, such as a situation when a driver cancels a pairing immediately before a pick-up time desired by the rider, a driver having a response time relatively shorter than those of other drivers may be extracted preferentially as the candidate driver. As a result, since it is easy to promptly obtain the response to the confirmation of intention from the candidate driver, it is easy to determine a driver who is to share a vehicle with the rider in a relatively short time. Therefore, the driver who is to share a vehicle with the rider can be efficiently determined.

Here, when extracting the candidate driver, the control unit may calculate an evaluation value of each user based on the ride-sharing condition information and the usage tendency information. Then, the control unit may preferentially extract, as the candidate driver, a user having a high evaluation value over a user having a low evaluation value. Here, the “evaluation value” indicates a degree of priority when the control unit extracts the candidate driver. By using such an evaluation value, the candidate driver can be more efficiently extracted.

The control unit may calculate the evaluation value in such a manner that a user having a short response time to the confirmation of intention has a higher evaluation value than a user having a long response time. As such, when the control unit extracts the candidate driver, the user having the short response time to the confirmation of intention can be preferentially extracted as the candidate driver. Since a response can be obtained from the candidate driver in a shorter time when the confirmation of intention is executed on the candidate driver extracted in the above manner, a driver who is to share his/her vehicle with the rider can be promptly determined.

In addition, the usage tendency information may further include information on the number of times each of the users has used the ride-sharing for each time range. Moreover, the control unit may calculate the evaluation value in such a manner that a user having a greater number of times of using the ride-sharing during the movement time range desired by the rider has a higher evaluation value than a user having a smaller number of times of using the ride-sharing during the movement time range desired by the rider. This is because the former is more likely to travel during the movement time range desired by the rider than the latter, such that the former is likely to make a positive response to the confirmation of intention (acceptance of sharing his/her vehicle with the rider). When the control unit extracts the candidate driver based on the evaluation value calculated in the above manner, the candidate driver who easily makes the positive response to the confirmation of intention can be more reliably determined. As a result, a driver who is to share his/her vehicle with the rider can be more efficiently extracted. Further, the number of times of using the ride-sharing for each movement time range may be divided by days of the week or weather conditions. In this case, the control unit may calculate the evaluation value in such a manner that a user having a greater number of times of using the ride-sharing during the same time range as a movement time range desired by the rider on the same day of the week as a movement day desired by the rider has a higher evaluation value than a user having a smaller number of times of using the ride-sharing. In addition, the control unit may calculate the evaluation value in such a manner that a user having a greater number of times of using the ride-sharing during the same time range as a movement time range desired by the rider in the same weather conditions as those during the movement time range has a higher evaluation value than a user having a smaller number of times of using the ride-sharing.

Further, the usage tendency information may further include information on an acceptance rate, which is a rate at which a user made positive responses to the confirmation of intention in the past (for example, a rate of the number of times a user made positive responses to the number of times the user received the confirmation of intention in the past). In addition, the control unit may calculate the evaluation value in such a manner that a user having a high acceptance rate has a higher evaluation value than a user having a low acceptance rate. As such, when the control unit extracts the candidate driver, the user having the high acceptance rate can be preferentially extracted as the candidate driver. When the confirmation of intention is executed on the candidate driver extracted in the above manner, a driver who is to share his/her vehicle with the rider can be more efficiently determined.

### Embodiment

In the present embodiment, an example in which the present disclosure is implemented in a form (the ride-sharing) in which a plurality of users share the same vehicle for commuting will be described. In addition, an automobile, a train, or the like, can be used as a vehicle that can be shared by the plurality of users for commuting, but an example in which an automobile is used will be described in the present embodiment.

Overview of Ride-Sharing

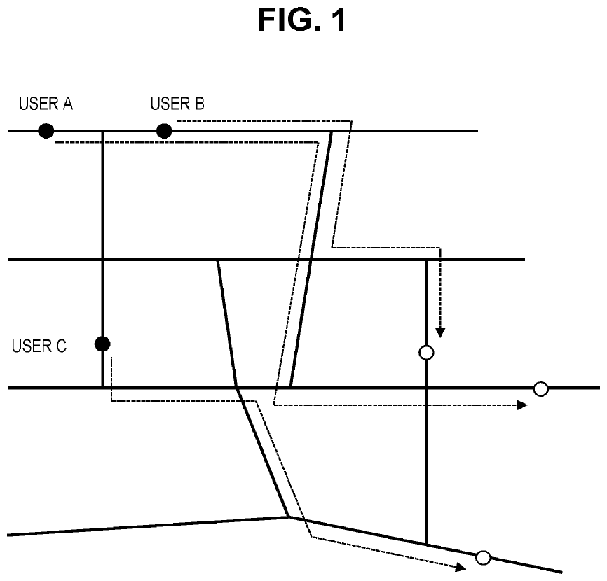

First, an overview of the ride-sharing will be described. FIG. 1 is a diagram exemplifying respective commuting routes when there are three users who regularly travel in order to commute. Black circles represent users' homes which are departure locations, and white circles represent their workplaces which are destinations. At the time of going to work, users A to C respectively depart from their homes and travel to their workplaces along routes represented by dotted lines, and at the time of leaving work, they respectively travel along reverse routes.

When each of the users A to C commutes separately, three vehicles are needed. However, when they share vehicles, the number of traveling vehicles can be reduced. For example, since the homes and the workplaces of the user A and the user B are close to each other, they can share the same vehicle when their times to go to work and to leave work are similar. For example, when the commute route of the user A is changed to a route that passes by the home and the workplace of the user B, the user B can share the vehicle driven by the user A.

In the above manner, partners who are to share a vehicle can be matched based on their respective departure locations and destinations (a movement section). Further, when matching is executed in consideration of a departure time and an arrival time (a movement time range) desired by the user, convenience can be further increased.

However, when the user A and the user B share the same vehicle and commute, it may become difficult for the user A and the user B to share the same vehicle when returning home in a form in which the time to leave work of the user A or the user B is changed from an initial schedule. At this time, between the user A and the user B, the user (the driver) who drives the vehicle can return home with the vehicle driven by himself/herself, but the user (the rider) who has desired to share the vehicle as a non-driver needs to find an alternative driver in order to secure transportation to return home. At this time, when the time to leave work, and the like, of the user A or the user B is changed immediately before the initial schedule (for example, after the user A and the user B arrive at their workplaces), the alternative driver should be found in a relatively short time. When such a situation occurs, in the present embodiment, a server device configured to execute information processing related to an operation and management of the ride-sharing service executes a re-matching process for the rider in consideration of a tendency in using the ride-sharing of each user.

System Configuration

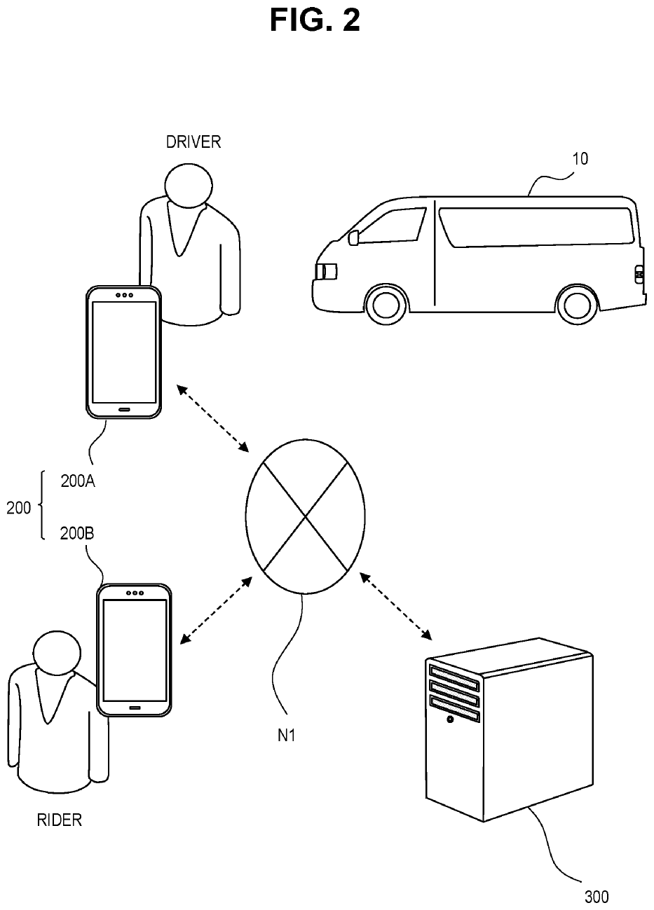

FIG. 2 is a diagram illustrating one example of a configuration of a system that provides the ride-sharing service (hereinafter, sometimes referred to as a “ride-sharing system”). In the example illustrated in FIG. 2, the ride-sharing system includes a vehicle (a shared vehicle) 10 used for the ride-sharing, a user terminal 200 used by a user who is to share the shared vehicle 10, and a server device 300. The user terminal 200 and the server device 300 can be connected to each other via a network N1. As the network N1, for example, a wide area network (WAN), which is a global public communication network, such as the Internet, or other communication networks may be employed. Further, the network N1 may include a telephone communication network, such as a mobile phone, and a wireless communication network, such as WiFi.

Moreover, in the example illustrated in FIG. 2, only one vehicle 10 is illustrated as a shared vehicle, but it is assumed that shared vehicles of the number of vehicles registered as vehicles that can be used in the ride-sharing service are included in the ride-sharing system. Further, in the example illustrated in FIG. 2, only two user terminals, which are a first user terminal 200A used by the driver and a second user terminal 200B used by the rider, are illustrated as the user terminal 200, but it is assumed that user terminals as many as the number of users registered as members who can use the ride-sharing service are included in the ride-sharing system.

A predetermined application for using the ride-sharing service is installed in the user terminal 200. A user of the user terminal 200 can register information (hereinafter, sometimes referred to as “request information”) on a condition for sharing the vehicle, or the like, in the server device 300 by causing the user terminal 200 to execute the predetermined application. For example, by causing the first user terminal 200A to execute the predetermined application, the driver can register in the server device 300, as request information, information (a travel schedule) on a travel section (a departure location and a destination) for commuting with the shared vehicle 10 driven by himself/herself, or on a scheduled travel time range (a time range from a scheduled departure time to a scheduled arrival time) for the section, and on a seating capacity of the shared vehicle 10 driven by the driver, or the like. On the other hand, by causing the second user terminal 200B to execute the predetermined application, the rider can register in the server device 300, as request information, information (a movement schedule) on a desired movement section (a desired pick-up location and a desired drop-off location) with the shared vehicle 10 driven by another user for commuting, or on a movement time range (a time range from a desired pick-up time to a desired drop-off time) for the section, or the like. Further, the request information of the driver and the rider may include a condition for an attribute (gender, age, occupation, smoking status, or the like) of a sharing partner.

The server device 300 receives the request information from the driver and the request information from the rider. Then, the server device 300 determines a provisional pairing between the driver and the rider based on the request information from the driver and the request information from the rider. For example, first, the server device 300 sets a route (a commuting route) on which the shared vehicle 10 driven by the driver travels in a section from the departure location to the destination of the driver (for example, from home to the workplace or from the workplace to home). Subsequently, the server device 300 provisionally pairs the driver and a rider whose desired pick-up location and desired drop-off location are located on the set commuting route or in the vicinity thereof, and whose desired movement time range differs from the scheduled travel time range of the shared vehicle 10 driven by the driver within an allowable range. The server device 300 inquires (executes confirmation of intention) of the driver and the rider who compose the above provisional pairing regarding their intention of sharing the vehicle by transmitting information indicating the condition for the ride-sharing to each of the user terminals 200 of the driver and the rider. Then, upon receiving information (a positive response to the confirmation of intention) of an acceptance of the condition for the ride-sharing from each of the user terminals 200 of the driver and the rider, the server device 300 confirms the above provisional pairing as a formal pairing. Hereinafter, the process in which the server device 300 confirms the pairing between the driver and the rider in the above procedure is referred to as a “matching process”.

In addition, when it is necessary to re-determine a new driver who is to share his/her vehicle with the rider, such as a situation when the driver cancels a matched pairing, after the completion of matching the driver with the rider, the server device 300 also has a function of executing a process (the re-matching process) of re-determining a new driver who can share his/her vehicle with the rider. At this time, when the time remaining until the pick-up time desired by the rider is sufficient (for example, when the driver cancels the matched pairing before the previous day of a pick-up day desired by the rider), the server device 300 executes the re-matching process in the same manner as the matching process described above. On the other hand, when the time remaining until the pick-up time desired by the rider is insufficient (for example, when the driver cancels the matched pairing on the same day as the pick-up day or immediately before the pick-up time desired by the rider), the server device 300 determines an alternative driver by extracting the candidate driver for an alternative driver in consideration of the usage tendency information of each user and executing confirmation of intention to the extracted candidate driver.

The server device 300 having the above functions may function as an “information processing device” according to the present disclosure.

Hardware Configuration

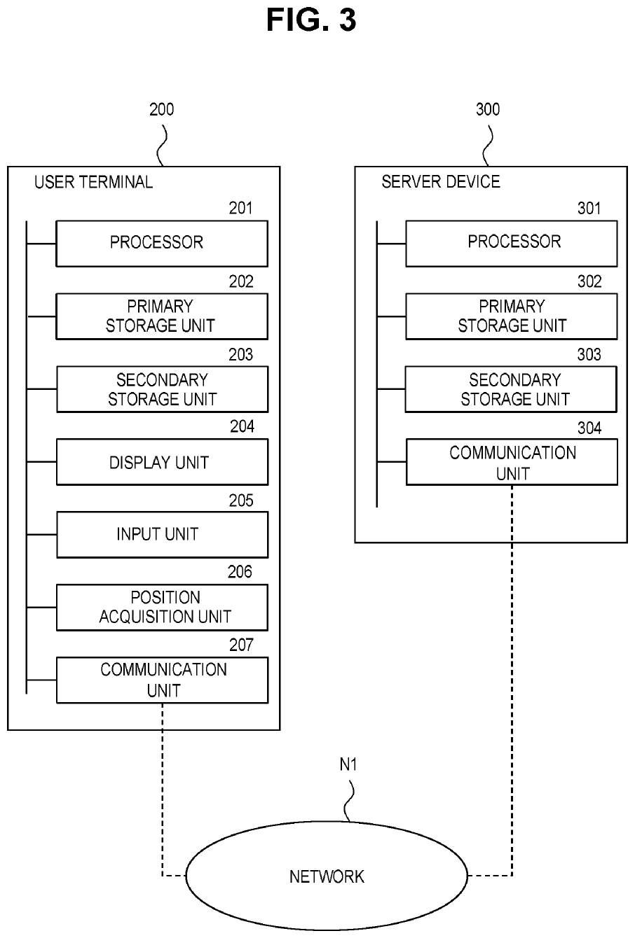

FIG. 3 is a diagram exemplifying a hardware configuration of each of the user terminal 200 and the server device 300. Moreover, it is assumed that the first user terminal 200A and the second user terminal 200B illustrated in FIG. 2 have the same hardware configuration as that of the user terminal 200 in FIG. 3.

The server device 300 has a general computer configuration. In other words, the server device 300 includes a processor 301, a primary storage unit 302, a secondary storage unit 303, and a communication unit 304. They are connected to each other via buses. The primary storage unit 302 and the secondary storage unit 303 are computer-readable recording media. The hardware configuration of the computer is not limited to the example illustrated in FIG. 3, and components may be appropriately omitted, replaced, or added.

In the server device 300, the processor 301 loads a program stored in a recording medium into a work area of the primary storage unit 302 and executes the program, and each functional component unit, and the like, is controlled through the execution of the program, thereby realizing a function that matches a predetermined purpose.

The processor 301 may be, for example, a central processing unit (CPU) or a digital signal processor (DSP). The processor 301 controls the server device 300 and executes operation of various information processing. The primary storage unit 302 may include, for example, a random access memory (RAM) or a read-only memory (ROM). The secondary storage unit 303 may be, for example, an erasable programmable ROM (EPROM) or a hard disk drive (HDD). In addition, the secondary storage unit 303 may include a removable medium, that is, a portable recording medium. The removable medium may be, for example, a universal serial bus (USB) memory, or a disc recording medium, such as a compact disc (CD) and a digital versatile disc (DVD).

The secondary storage unit 303 stores various programs, various pieces of data, and various tables in the recording medium in a readable and writable manner. The secondary storage unit 303 stores an operating system (OS), various programs, various tables, and the like. Moreover, part or all of the information may be stored in the primary storage unit 302. The information stored in the primary storage unit 302 may be stored in the secondary storage unit 303.

The communication unit 304 transmits and receives information between an external device and the server device 300. The communication unit 304 may be, for example, a local area network (LAN) interface board or a wireless communication circuit for wireless communication. The LAN interface board or the wireless communication circuit is connected to the network N1.

A series of processes executed by the server device 300 configured as described above may be executed by hardware, but may also be executed by software.

Next, the user terminal 200 may be, for example, a small computer that can be carried by the user, such as a smartphone, a mobile phone, a tablet terminal, a personal information terminal, and a wearable computer (for example, a smart watch). The user terminal 200 may be a personal computer (PC) connected to the server device 300 via the network N1, such as the Internet, which is a public communication network.

The user terminal 200 includes a processor 201, a primary storage unit 202, a secondary storage unit 203, a display unit 204, an input unit 205, a position acquisition unit 206, and a communication unit 207. Since the processor 201, the primary storage unit 202, and the secondary storage unit 203 are the same as the processor 301, the primary storage unit 302, and the secondary storage unit 303 of the server device 300, description thereof is omitted. The display unit 204 may be, for example, a liquid crystal display (LCD), or an electroluminescence (EL) panel. The input unit 205 may include, for example, a touch panel and a push button through which a symbol, such as text, can be input, a microphone through which the voice can be input, and a camera capable of capturing a moving image or a still image. The position acquisition unit 206 is a device that acquires a current position of the user terminal 200 and typically includes a GPS receiver, and the like. The communication unit 207 is a communication circuit that accesses the network N1 using, for example, a mobile communication service (telephone communication network, such as a mobile phone, or wireless communication, such as WiFi), and executes data communication with the server device 300, and the like.

Functional Configuration of Server Device

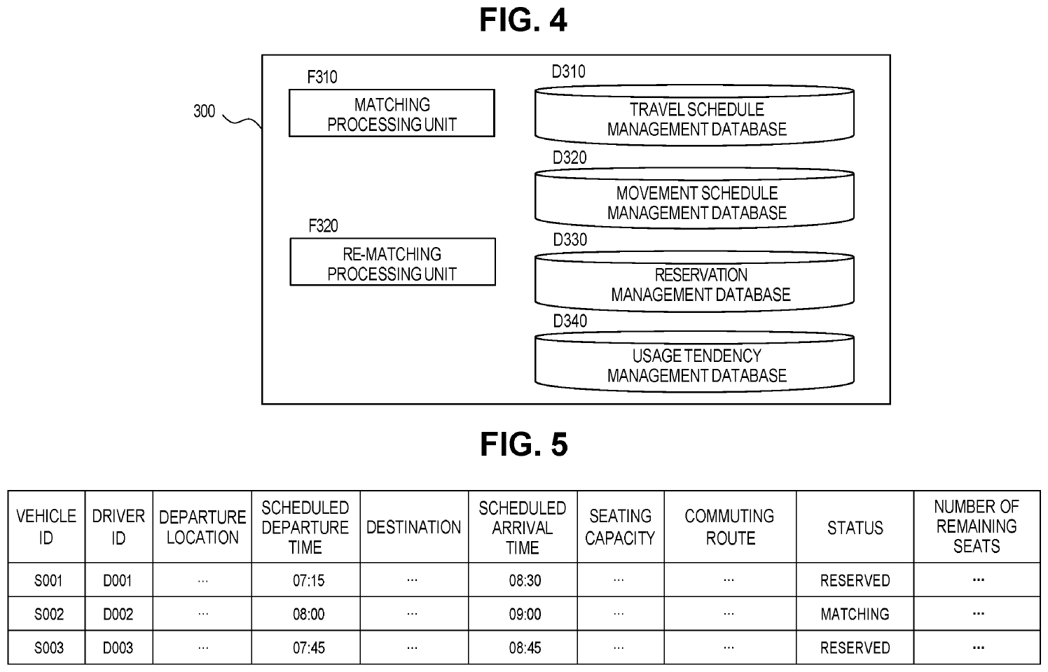

Here, a functional configuration of the server device 300 will be described with reference to FIG. 4. As illustrated in FIG. 4, the server device 300 according to the present embodiment includes, as functional components, a matching processing unit F310, a re-matching processing unit F320, a travel schedule management database D310, a movement schedule management database D320, a reservation management database D330, and a usage tendency management database D340. The matching processing unit F310 and the re-matching processing unit F320 are formed when the processor 301 of the server device 300 executes a computer program on the primary storage unit 302. Further, any one or a part of the matching processing unit F310 and the re-matching processing unit F320 may be formed by a hardware circuit.

The travel schedule management database D310, the movement schedule management database D320, the reservation management database D330, and the usage tendency management database D340 are established when a program of a database management system (DBMS) executed by the processor 301 of the server device 300 manages the data stored in the secondary storage unit 303. The travel schedule management database D310, the movement schedule management database D320, the reservation management database D330, and the usage tendency management database D340 may be, for example, relational databases.

In addition, any one of the functional components of the server device 300 or part of processing thereof may be executed by another computer connected to the network N1. For example, each process included in the matching processing unit F310 and each process included in the re-matching processing unit F320 may be executed by different computers.

The travel schedule management database D310 stores a travel schedule of each shared vehicle 10. Here, identification information of the driver who is the user desiring to drive the shared vehicle 10 is associated with the travel schedule of the shared vehicle 10. A configuration example of the travel schedule information stored in the travel schedule management database D310 will be described with reference to FIG. 5. FIG. 5 is a diagram illustrating a configuration example of a travel schedule information table. Further, the information registered in the travel schedule information table is not limited to the example illustrated in FIG. 5, and fields may be appropriately added, modified, or omitted.

The travel schedule information table illustrated in FIG. 5 has fields for a vehicle ID, a driver ID, a departure location, a scheduled departure time, a destination, a scheduled arrival time, the seating capacity, a commuting route, a status, the number of remaining seats, and the like. In the vehicle ID field, a vehicle ID that is information for identifying each shared vehicle 10 is registered. The vehicle ID referred to here is information given to the driver when the driver of each shared vehicle 10 registers as a member of the ride-sharing service, together with a user ID to be described below. In a driver ID field, a user ID that is information for identifying a driver of each shared vehicle 10 is registered. The user ID is information given to the driver when the driver of the shared vehicle 10 registers as a member of the ride-sharing service. In a departure location field, information indicating a departure location (for example, a home or a workplace) of each shared vehicle 10 is registered. In a scheduled departure time field, information indicating a scheduled time of departure from the departure location using the shared vehicle 10 driven by the driver is registered. In a destination field, information indicating a destination (for example, a workplace or a home) to which the driver is headed using the shared vehicle 10 is registered. In a scheduled arrival time field, information indicating the scheduled time of arrival at the destination using the shared vehicle 10 driven by the driver is registered. In a seating capacity field, information indicating the number of riders who can ride each shared vehicle 10 is registered. In a commuting route field, information indicating a route on which the shared vehicle 10 can travel from the departure location to the destination of the driver is registered. In addition, the route refers to a route on which it is predicted that the shared vehicle 10 driven by the driver will be able to reach the destination by the scheduled arrival time. In a status field, information indicating a reservation status of each shared vehicle 10 is registered. For example, the shared vehicle 10 for which a reservation has already been confirmed is registered as “reserved”. Further, the shared vehicle 10 for which the matching process between the driver and the rider is being executed is registered as “matching”. In a number of remaining seats field, the number of remaining seats in each shared vehicle 10 (the number obtained by subtracting the number of riders who are confirmed to share each shared vehicle 10 from the seating capacity) is registered. For example, when the number of riders who have been confirmed to share the shared vehicle 10 is one and the shared vehicle 10 has the seating capacity of three, “2” is registered in the number of remaining seats field.

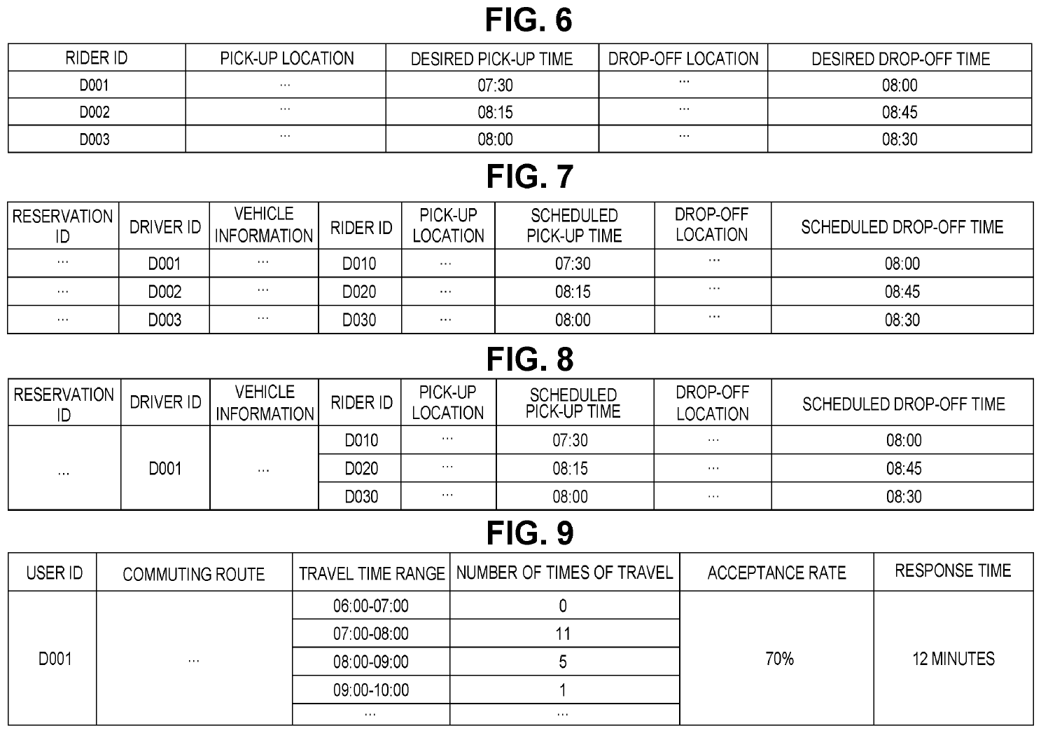

The movement schedule management database D320 stores a movement schedule of the rider who desires to share the vehicle 10 driven by another user. Here, identification information of the rider is associated with the movement schedule. A configuration example of the movement schedule information stored in the movement schedule management database D320 will be described with reference to FIG. 6. FIG. 6 is a diagram illustrating a configuration example of a movement schedule information table. Further, the information registered in the movement schedule information table is not limited to the example illustrated in FIG. 6, and fields may be appropriately added, modified, or omitted.

The movement schedule information table illustrated in FIG. 6 has fields for a rider ID, a pick-up location, a desired pick-up time, a drop-off location, a desired drop-off time, and the like. In a rider ID field, a user ID that is information for identifying each rider is registered. The user ID of the rider is information given to the rider when the rider registers as a member of the ride-sharing service, similar to the driver ID described above. In a pick-up location field, information indicating a location (a desired pick-up location) at which each rider desires to be picked up by the shared vehicle 10 is registered. In a desired pick-up time field, information indicating a time at which each rider desires to be picked up by the shared vehicle 10 at the desired pick-up location is registered. In a drop-off location field, information indicating a location (a desired drop-off location) at which each rider desires to be dropped off by the shared vehicle 10 is registered. In a desired drop-off time field, information indicating a time at which each rider desires to be dropped off by the shared vehicle 10 at the desired drop-off location is registered.

The reservation management database D330 stores reservation information of the ride-sharing service. Here, the information on the driver is associated with the information on the rider who is scheduled to share the shared vehicle 10 driven by the driver. A configuration example of the reservation information stored in the reservation management database D330 will be described with reference to FIG. 7. FIG. 7 is a diagram illustrating a configuration example of a reservation information table. Further, the information registered in the reservation information table is not limited to the example illustrated in FIG. 7, and fields may be appropriately added, modified, or omitted.

The reservation information table illustrated in FIG. 7 has fields for a reservation ID, the driver ID, vehicle information, the rider ID, the pick-up location, the scheduled pick-up time, the drop-off location, a scheduled drop-off time, and the like. In a reservation ID field, the reservation ID that is information for identifying individual reservation information is registered. The reservation ID is used when, for example, each user confirms or modifies the content of the reservation. In a driver ID field, the user ID of the driver who drives the shared vehicle 10 is registered. In a vehicle information field, information necessary in order for the rider who is scheduled to share the shared vehicle 10 to identify the shared vehicle 10 driven by each driver is registered. For example, in the vehicle information field, information such as a vehicle type, a vehicle registration number (a number marked on a license plate), and a vehicle body color, is registered. In a rider ID field, the user ID of the rider who is scheduled to share the vehicle 10 driven by each driver is registered. In a pick-up location field, information indicating a location (the scheduled pick-up location) where each driver is scheduled to pick up the rider in the shared vehicle 10 driven by the driver is registered. In a scheduled pick-up time field, information indicating a scheduled time at which each driver will pick up the rider in the shared vehicle 10 driven by the driver at the scheduled pick-up location is registered. In a drop-off location field, information indicating a location (the scheduled drop-off location) where each driver is scheduled to drop off the rider from the shared vehicle 10 driven by the driver is registered. In a scheduled drop-off time field, information indicating a scheduled time at which each driver will drop off the rider from the shared vehicle 10 driven by the driver at the scheduled drop-off location is registered.

The reservation information table in FIG. 7 illustrates an example of a table configuration of a case in which one rider shares the shared vehicle 10 driven by each driver, but the number of riders who is to share the shared vehicle 10 driven by each driver may be two or more. In this case, as illustrated in FIG. 8, information on a plurality of riders may be associated with one driver ID.

The usage tendency management database D340 stores information indicating a tendency in using the ride-sharing of each user. Here, the identification information of the user who used the ride-sharing as a driver in the past is associated with the usage tendency information. A configuration example of the usage tendency information stored in the usage tendency management database D340 will be described with reference to FIG. 9. FIG. 9 is a diagram illustrating a configuration example of a reservation information table. Further, the information registered in the reservation information table is not limited to the example illustrated in FIG. 9, and fields may be appropriately added, modified, or omitted.

The usage tendency information table illustrated in FIG. 9 includes fields for the user ID, the commuting route, a travel time range, the number of times of travel, the acceptance rate, the response time, and the like. In a user ID field, the user ID of the user who used the ride-sharing as the driver in the past is registered. The user ID is, as described above, given to each user when each user registers as a member of the ride-sharing service. In the commuting route field, information indicating the commuting route of each user is registered. In a travel time range field, information in which a time range during which the shared vehicle 10 driven by each user can travel on the commuting route is divided by a predetermined time unit (one hour unit in the example illustrated in FIG. 9) is registered. In a number of times of travel field, information indicating the number of times the shared vehicle 10 driven by the user traveled on the commuting route in the past in each time range registered in the travel time range field is registered. For example, “0” is registered in the number of times of travel field corresponding to the time range of 06:00 to 07:00 in the travel time range field. This means that the number of times the shared vehicle 10 driven by the user traveled on the commuting route in the past is “0” in the time range of 06:00 to 07:00. In addition, “11” is registered in the number of times of travel field corresponding to the time range of 07:00 to 08:00 in the travel time range field. This means that the number of times the shared vehicle 10 driven by the user traveled on the commuting route in the past is “11” in the time range of 07:00 to 08:00. The number of times registered in the number of times of travel field may be the number of times the user has traveled in the period from when the user is registered as a member of the ride-sharing service to the current time, or the number of times the user has traveled in the most recent predetermined period (for example, the period from a few months ago to the current time). In an acceptance rate field, information indicating the rate at which the user made positive responses to the above-described confirmation of intention in the past (the rate of the number of times a user made positive responses to the number of times the user received the confirmation of intention in the past, hereinafter referred to as the “acceptance rate”) is registered. For example, when the number of times the confirmation of intention was executed to the user in the past is 10 and the number of times the user made positive responses is 7, “70%” is registered in the acceptance rate field. Further, in a response time field, information indicating the response time (an average value) of when the user responded to the confirmation of intention in the past is registered. Moreover, the acceptance rate and/or the response time may be divided by each travel time range, and registered. In addition, the usage tendency information table may be divided by days of the week and/or weather conditions.

Next, the matching processing unit F310 executes a matching process based on the request information from the driver or the rider. Specifically, when the server device 300 receives the request information transmitted from the user terminal 200 of the driver, the matching processing unit F310 extracts all routes that connect the departure location and destination included in the request information and on which the shared vehicle 10 can pass. Subsequently, the matching processing unit F310 sets, as the commuting route, a route on which it is predicted that the shared vehicle 10 driven by the driver will be able to reach the destination by the scheduled arrival time included in the request information, from among the extracted routes. At this time, the matching processing unit F310 may set the commuting route in consideration of traffic congestion prediction information, traffic regulation information, and the like, in the time range when the driver travels from the departure location to the destination. When the commuting route is set by such a method, the matching processing unit F310 generates the travel schedule information table as illustrated in FIG. 5 based on the request information from the driver and the commuting route, and stores the generated travel schedule information table in the travel schedule management database D310. In addition, when the server device 300 receives the request information transmitted from the user terminal 200 of the rider, the matching processing unit F310 generates the movement schedule information table as illustrated in FIG. 6 based on the request information, and stores the generated movement schedule information table in the movement schedule management database D320. Then, the matching processing unit F310 compares the travel schedule information table stored in the travel schedule management database D310 with the movement schedule information table stored in the movement schedule management database D320, and extracts the travel schedule matching the movement schedule of the rider. For example, the matching processing unit F310 first extracts the travel schedule information table including the commuting route field in which the commuting route that passes by the desired pick-up location registered in the pick-up location field and the desired drop-off location registered in the drop-off location field in the movement schedule information table of the rider is registered. Subsequently, the matching processing unit F310 extracts, from among the travel schedule information tables extracted as above, the travel schedule information table in which a scheduled travel time range (a time range from the scheduled departure time registered in the scheduled departure time field to the scheduled arrival time) including a desired movement time range (a time range from the desired pick-up time registered in the desired pick-up time field to the desired drop-off time) is calculated. The desired movement time range is calculated in the movement schedule information table of the rider. In this manner, upon extracting the travel schedule matching the movement schedule of the rider, the matching processing unit F310 provisionally pairs the rider with the driver who is associated with the extracted travel schedule information table. When the provisional paring between the driver and the rider is determined, the matching processing unit F310 executes the confirmation of intention for ride-sharing by transmitting, to the user terminals 200A, 200B of the driver and the rider who compose the above provisional pairing, respectively, information indicating the conditions for the ride-sharing (for example, the pick-up location desired by the rider, the pick-up time desired by the rider, the drop-off location desired by the rider, the drop-off time desired by the rider, the commuting route of the driver, or the type of shared vehicle 10). Upon receiving information of an acceptance of the conditions for the ride-sharing from the user terminals 200A, 200B of both the driver and the rider in response to the confirmation, the matching processing unit F310 confirms the provisional pairing as a formal pairing. Accordingly, the matching processing unit F310 generates the reservation information table as illustrated in FIGS. 7 and 8 based on the formal pairing, and stores the generated reservation information table in the reservation management database D330.

Next, when it is necessary to re-determine a new driver who is to share his/her vehicle with the rider (hereinafter, sometimes referred to as a “re-matching request”) due to an occurrence of a situation such as when the driver cancels a matched paring after the matching processing unit F310 completed the matching between the driver and the rider, the re-matching processing unit F320 executes the re-matching process. At this time, when the time remaining (hereinafter, sometimes referred to as a “grace period”) until the pick-up time desired by the rider after the occurrence of the re-matching request is sufficiently long (for example, when the driver cancels the matched pairing before the previous day of a pick-up day desired by the rider from the driver, or the like, occurs), the re-matching processing unit F320 determines a new driver who is to share his/her vehicle with the rider (a normal matching process) in the same manner as the matching processing unit F310 described above. On the other hand, when the grace period is short (for example, when the driver cancels the matched pairing on the same day as the pick-up day or immediately before the pick-up time desired by the rider), the re-matching processing unit F320 determines a new driver who is to share his/her vehicle with the rider based on the usage tendency information of each user, which is registered in the usage tendency management database D340 (an emergency matching process).

In the emergency matching process, with reference to the travel schedule management database D310, the re-matching processing unit F320 first specifies the travel schedule information table of each driver, which is stored in the travel schedule management database D310, and specifies the travel schedule information table in which the number of “1” or greater is registered in the number of remaining seats field from among the travel schedule information tables in which the travel schedule matching the movement schedule of the rider is registered. Then, the re-matching processing unit F320 extracts, as a first candidate driver, the driver associated with the travel schedule information table specified in this manner. Subsequently, the re-matching processing unit F320 narrows down the range of candidate drivers with reference to the usage tendency information table stored in the usage tendency management database D340. Specifically, the re-matching processing unit F320 accesses the response time field in the usage tendency information table corresponding to each of the first candidate drivers, and extracts, from among the first candidate drivers, the user having the response time shorter than the grace period. Then, the re-matching processing unit F320 sets the user extracted from among the first candidate drivers in this manner as a final candidate driver. Moreover, when a large number of users having response times shorter than the grace period are included in the first candidate drivers, the re-matching processing unit F320 may set, as the final candidate drivers, the predetermined number (for example, three to five) of upper-ranked users in order of the shortest response time. When the final candidate drivers are extracted in this manner, the re-matching processing unit F320 executes the confirmation on whether the driver has an intention to share his/her shared vehicle 10 with the rider by transmitting, to each of the user terminals 200 of the extracted candidate drivers, the information on the conditions for the ride-sharing (for example, the pick-up location desired by the rider, the pick-up time desired by the rider, the drop-off location desired by the rider, or the drop-off time desired by the rider). Then, upon receiving the information of an acceptance of sharing his/her shared vehicle 10 with the rider from the user terminal 200 of any one of the candidate drivers, the re-matching processing unit F320 determines the candidate driver who sent the information of acceptance as the driver who is to share his/her shared vehicle 10 with the rider.

Here, it can also be assumed that the travel schedule information table, in which the travel schedule matching the movement schedule of the rider is registered, is not stored in the travel schedule management database D310 (when there is no user corresponding to the first candidate driver). In such a case, the re-matching processing unit F320 accesses the usage tendency management database D340 and specifies the usage tendency information table in which the commuting route that passes by the pick-up location and the drop-off location desired by the rider is registered in the commuting route field. Then, the re-matching processing unit F320 extracts, as a second candidate driver, the user associated with the usage tendency information table specified in this manner. Subsequently, the re-matching processing unit F320 calculates an evaluation value Eᵥ of each of the second candidate drivers. Such an evaluation value Eᵥ is calculated based on at least the response time from among the number of times of travel, the acceptance rate, the response time, and the like, in the travel time range corresponding to the movement time range desired by the rider. In the present example, the evaluation value Eᵥ, is calculated according to the following equation (1):

Eᵥ=A₁+A₂+A₃ (1)

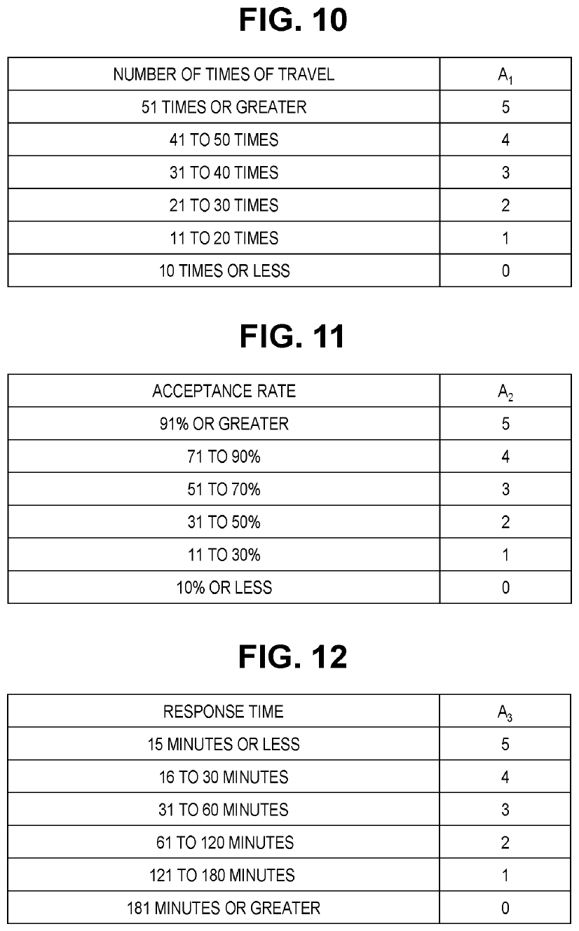

A₁ in the above equation (1) is a first coefficient set based on the number of times of travel in the travel time range corresponding to the movement time range desired by the rider. The first coefficient A₁ may be set, for example, based on the references illustrated in FIG. 10. In the example illustrated in FIG. 10, when the number of times of travel in the travel time range corresponding to the movement time range desired by the rider is 51 or greater, the first coefficient A₁ is set to “5”, when the number of times of travel is 41 or greater and 50 or less, the first coefficient A₁ is set to “4”, when the number of times of travel is 31 or greater and 40 or less, the first coefficient A₁ is set to “3”, when the number of times of travel is 21 or greater and 30 or less, the first coefficient A₁ is set to “2”, when the number of times of travel is 11 or greater and 20 or less, the first coefficient A₁ is set to “1”, and when the number of times of travel is equal to or less than 10, the first coefficient A₁ is set to “0”. In addition, the references illustrated in FIG. 10 are merely examples, and may be appropriately modified.

A₂ in the above equation (1) is a second coefficient set based on the acceptance rate. The second coefficient A₂ may be set, for example, based on the references illustrated in FIG. 11. In the example illustrated in FIG. 11, when the acceptance rate is 91% or greater, the second coefficient A₂ is set to “5”, when the acceptance rate is 71% or greater and 90% or less, the second coefficient A₂ is set to “4”, when the acceptance rate is 51% or greater and 70% or less, the second coefficient A₂ is set to “3”, when the acceptance rate is 31% or greater and 50% or less, the second coefficient A₂ is set to “2”, when the acceptance rate is 11% or greater and 30% or less, the second coefficient A₂ is set to “1”, and when the acceptance rate is equal to or less than 10%, the second coefficient A₂ is set to “0”. In addition, the references illustrated in FIG. 11 are merely examples, and may be appropriately modified.

A₃ in the above equation (1) is a third coefficient set based on the response time. The third coefficient A₃ may be set, for example, based on the references illustrated in FIG. 12. In the example illustrated in FIG. 12, when the response time is equal to or less than 15 minutes, the third coefficient A₃ is set to “5”, when the response time is 16 minutes or greater and 30 minutes or less, the third coefficient A₃ is set to “4”, when the response time is 31 minutes or greater and 60 minutes or less, the third coefficient A₃ is set to “3”, when the response time is 61 minutes or greater and 120 minutes or less, the third coefficient A₃ is set to “2”, when the response time is 121 minutes or greater and 180 minutes or less, the third coefficient A₃ is set to “1”, and when the response time is 181 minutes or greater, the third coefficient A₃ is set to “0”. In addition, the references illustrated in FIG. 12 are merely examples, and may be appropriately modified.

Upon calculating the evaluation value Eᵥ of each of the second candidate drivers according to the above equation (1), the re-matching processing unit F320 sets, as the final candidate drivers, the predetermined number (for example, three to five) of upper-ranked users in descending order of the evaluation value Eᵥ among the second candidate drivers. When the final candidate drivers are extracted in this manner, the re-matching processing unit F320 executes the confirmation on whether the driver has an intention to share his/her shared vehicle 10 with the rider by transmitting, to each of the user terminals 200 of the extracted candidate drivers, the information on the conditions for the ride-sharing. Then, upon receiving the information of an acceptance of sharing his/her shared vehicle 10 with the rider from any one of the candidate drivers, the re-matching processing unit F320 determines the candidate driver who sent the information of the acceptance as the driver who is to share his/her shared vehicle 10 with the rider.

Further, when the re-matching processing unit F320 does not receive information of an acceptance of sharing his/her shared vehicle 10 with the rider from among any one of the final candidate drivers, the re-matching processing unit F320 executes the confirmation of intention to the users having the highest evaluation values Eᵥ next to the predetermined number of upper-ranked users in descending order of the evaluation value Eᵥ among the second candidate drivers.

Processing Flow

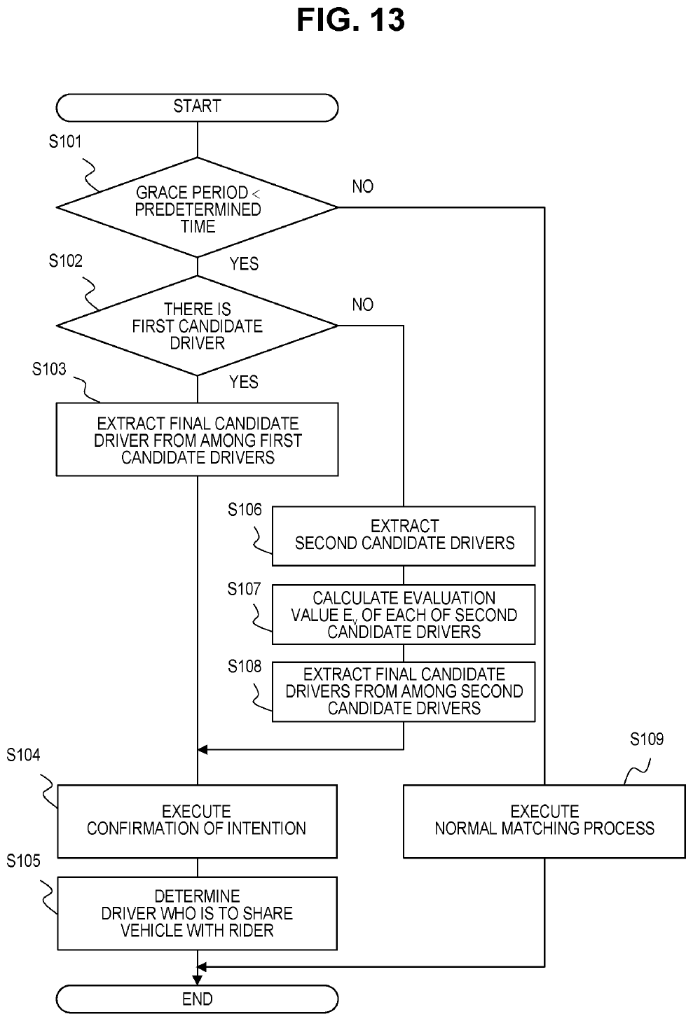

A processing flow of the server device 300 according to the present embodiment will be described with reference to FIG. 13. FIG. 13 is a flowchart illustrating a process (the re-matching process) executed in the server device 300 in response to the occurrence of the re-matching request.

In FIG. 13, when a re-matching request occurs due to a situation such as when the driver cancels a matched ride-sharing after the completion of matching, the re-matching processing unit F320 in the server device 300 determines whether the grace period is shorter than a predetermined time (step S101) Here, the “grace period” is, as described above, the remaining time from the time when the re-matching request occurs to the pick-up time desired by the rider to be subjected to the re-matching process. Moreover, the “predetermined time” is the minimum amount of time necessary for determining the driver who is to share his/her shared vehicle 10 with the rider by the normal matching process, or a time obtained by adding a margin to the minimum amount of time.

When the grace period is equal to or longer than the predetermined time (No in step S101), the re-matching processing unit F320 re-determines the driver who is to share his/her shared vehicle 10 with the rider by executing the above-described normal matching process (step S109).

When the grace period is shorter than the predetermined time (Yes in step S101), the re-matching processing unit F320 executes the emergency matching processing as described above. Specifically, the re-matching processing unit F320 first accesses the travel schedule management database D310, and determines whether the travel schedule information table, in which the travel schedule matching the movement schedule of the rider is registered, and the number of “1” or greater is registered in the number of remaining seats field, is stored in the travel schedule management database D310. In other words, the re-matching processing unit F320 determines whether there is a driver corresponding to the first candidate driver described above (step S102). At this time, when the travel schedule information table, in which the travel schedule matching the movement schedule of the rider is registered and the number of “1” or greater is registered in the number of remaining seats field, is stored in the travel schedule management database D310 (Yes in step S102), the re-matching processing unit F320 extracts, as the final candidate driver, the driver associated with the corresponding travel schedule information table, from among the first candidate drivers (step S103). Specifically, as described above, the re-matching processing unit F320 accesses the usage tendency management database D340, and refers to the response time field in the usage tendency information table corresponding to each of the first candidate drivers. Then, the re-matching processing unit F320 extracts, as the final candidate driver, the user having the response time, registered in the response time field in the usage tendency information table, shorter than the above-described grace period, from among the first candidate drivers.

The re-matching processing unit F320 executes the confirmation on whether the driver has an intention to share his/her shared vehicle 10 with the rider to each of the final candidate drivers extracted in step S103 (step S104). In other words, the re-matching processing unit F320 transmits the conditions for the ride-sharing with the rider to the user terminals 200 of the final candidate drivers. Upon receiving the information of an acceptance of sharing his/her shared vehicle 10 with the rider from the user terminal 200 of any one of the candidate drivers in response to such a confirmation of intention, the re-matching processing unit F320 determines the candidate driver who sent the information of the acceptance as the driver who is to share his/her shared vehicle 10 with the rider (step S105).

In addition, when a negative determination is made in step S102, the re-matching processing unit F320 extracts the user corresponding to the above-described second candidate drivers based on the usage tendency information table stored in the usage tendency management database D340 (step S106). Specifically, the re-matching processing unit F320 specifies the usage tendency information table in which the commuting route that passes by the pick-up location and the drop-off location desired by the rider is registered in the commuting route field. Then, the re-matching processing unit F320 extracts, as the second candidate driver, the user associated with the usage tendency information table specified in this manner.

The re-matching processing unit F320 calculates the evaluation value Eᵥ of each of the second candidate drivers extracted in step S106 (step S107). Specifically, the re-matching processing unit F320 first reads the number of times of travel, the acceptance rate, and the response time in the travel time range corresponding to the movement time range desired by the rider from the usage tendency information table corresponding to the second candidate drivers. Subsequently, the re-matching processing unit F320 sets the first coefficient A₁ based on the number of times of travel and the references as illustrated in FIG. 10. Further, the re-matching processing unit F320 sets the second coefficient A₂ based on the acceptance rate and the references as illustrated in FIG. 11. Moreover, the re-matching processing unit F320 sets the third coefficient A₃ based on the response time and the references as illustrated in FIG. 12. Thereafter, the re-matching processing unit F320 substitutes the first coefficient A₁, the second coefficient A₂, and the third coefficient A₃ to the above-described equation (1), and calculates the evaluation value of each of second candidate drivers (Eᵥ=A₁+A₂+A₃).

The re-matching processing unit F320 extracts the final candidate drivers from among the second candidate drivers extracted in step S106 by referring to the evaluation values Eᵥ calculated in step S107 (step S108). For example, the re-matching processing unit F320 sets, as the final candidate drivers, the predetermined number of upper-ranked users in descending order of the evaluation value Eᵥ from among the second candidate drivers. When the final candidate drivers are extracted in this manner, the re-matching processing unit F320 determines the driver who is to share his/her shared vehicle 10 with the rider by sequentially executing the processes in steps S104 and S105.

When the re-matching process is executed in the procedure as illustrated in FIG. 13, when it is necessary to re-determine the driver who is to share his/her shared vehicle 10 with the rider in a relatively short time, such as a situation when the driver cancels a matched pairing, immediately before the pick-up time desired by the rider after the matching between the driver and the rider is completed, it is possible to efficiently determine the driver who is to share his/her shared vehicle 10 with the rider by extracting the candidate drivers based on the usage tendency information of each user. As such, it is possible to restrict a decrease in convenience for the rider or a decrease in motivation of the rider to use the ride-sharing service. As a result, the use of the ride-sharing during commuting can be encouraged.

In addition, the evaluation values of the second candidate drivers may be registered in advance in the usage tendency information table. For example, in the usage tendency information table, a field for registering the evaluation value for each time range registered in the travel time range field may be provided together with the fields illustrated in FIG. 9 described above. Then, whenever data registered in the number of times of travel field, the acceptance rate field, or the response time field in the usage tendency information table is updated, the evaluation value may be calculated and the data registered in the evaluation value field may be updated.

### Embodiment Example

In the above-described embodiment, the case in which the ride-sharing is used during commuting has been exemplified, but the present disclosure may also be applied to a case in which ride-sharing is used for travel other than commuting. In short, when it is necessary to determine the driver who is to share his/her shared vehicle with the rider in a relatively short time, the driver who is to share his/her shared vehicle with the rider may be efficiently determined by extracting candidate drivers based on the usage tendency information of each user.

Others

Further, the above-described embodiment is merely an example, and the present embodiment can be implemented with appropriate modifications within the scope of the present disclosure.

Moreover, the processes and the elements described in the present disclosure can be freely combined and implemented as long as no technical inconsistency occurs. Furthermore, the processing described as being executed by one device may be shared and executed by a plurality of devices. Alternatively, the processing described as being executed by different devices may be executed by one device. In the computer system, what hardware configuration realizes each function can be flexibly changed.

The present embodiment can also be realized by supplying a computer with a computer program that implements the functions described in the above embodiments and modified examples, and reading and executing the program by one or more processors included in the computer. Such a computer program may be provided to a computer by a non-transitory computer-readable storage medium that can be connected to a system bus of the computer, or may be provided to the computer via a network. The non-transitory computer-readable storage medium is a storage medium that can store information, such as data and programs by electrical, magnetic, optical, mechanical, or chemical action, and can be read by a computer or the like, and may be, for example, any type of disk such as a magnetic disk (a Floppy® disk, a hard disk drive (HDD), and the like), an optical disk (a CD-ROM, a DVD disk, a Blu-ray disk, and the like), a read-only memory (ROM), a random access memory (RAM), an EPROM, an EEPROM, a magnetic card, a flash memory, an optical card, or a solid state drive (SSD).

What is claimed is:

1. An information processing device that determines a pairing between a driver who is a user driving a vehicle to be used for ride-sharing, and a rider who is another user, as a non-driver, desiring to share the vehicle with the driver, in a form in which a plurality of users share the same vehicle, the information processing device comprising:
a storage unit configured to store usage tendency information which is information on a tendency in using the ride-sharing of each of the users; and
a control unit configured to
acquire ride-sharing condition information including a movement section and a movement time range desired by the rider,
extract a candidate driver who is a candidate for a driver who has a possibility of sharing a vehicle with the rider based on the ride-sharing condition information and the usage tendency information,
present an inquiry to the candidate driver regarding an intention to share the vehicle with the rider,
determine a driver who is to share the vehicle with the rider based on a response to the inquiry, and
extract the candidate driver using information on a response time when the users responded to the inquiry in a past, wherein
the usage tendency information includes information on the response time.

2. The information processing unit according to claim 1, wherein the control unit is configured to calculate an evaluation value of each of the users based on the ride-sharing condition information and the usage tendency information and preferentially extract, as the candidate driver, a user having a high evaluation value over a user having a low evaluation value, and the control unit is configured to calculate the evaluation value in such a manner that a user having a short response time has a higher evaluation value than a user having a long response time.

3. The information processing device according to claim 2, wherein:
the usage tendency information further includes information on the number of times of using the ride-sharing by each of the users for each time range; and
the control unit is configured to calculate the evaluation value in such a manner that a user having a greater number of times of using the ride-sharing during the movement time range desired by the rider obtains a higher evaluation value than a user having a smaller number of times of using the ride-sharing during the movement time range desired by the rider.

4. The information processing device according to claim 2, wherein:
the usage tendency information further includes information on an acceptance rate, which is a rate at which each of the users made a positive response to the inquiry in the past; and
the control unit is configured to calculate the evaluation value in such a manner that a user having a high acceptance rate obtains a higher evaluation value than a user having a low acceptance rate.

5. An information processing method that determines a pairing between a driver who is a user driving a vehicle to be used for ride-sharing, and a rider who is another user, as a non-driver, desiring to share the vehicle with the driver, in a form in which a plurality of users share the same vehicle, the information processing method comprising
causing a computer, the computer including a storage unit configured to store usage tendency information which is information on a tendency in using the ride-sharing of each of the users, to execute:
acquiring ride-sharing condition information including a movement section and a movement time range desired by the rider;
extracting a candidate driver who is a candidate for a driver who has a possibility of sharing a vehicle with the rider based on the ride-sharing condition information and the usage tendency information;
presenting an inquiry to the candidate driver regarding an intention to share the vehicle with the rider;
determining a driver who is to share the vehicle with the rider based on a response to the inquiry; and
extracting the candidate driver using information on a response time, when the users responded to the inquiry in a past, wherein
the usage tendency information includes information on the response time.

6. A non-transitory storage medium storing an information processing program that determines a pairing between a driver who is a user driving a vehicle, and a rider who is another user, as a non-driver, desiring to share the vehicle with the driver, in a form in which a plurality of users share the same vehicle, the information processing program causing a computer, the computer including a storage unit configured to store usage tendency information which is information on a tendency in using the ride-sharing of each of the users, to perform functions comprising:
acquiring ride-sharing condition information including a movement section and a movement time range desired by the rider;
extracting a candidate driver who is a candidate for a driver who has a possibility of sharing a vehicle with the rider based on the ride-sharing condition information and the usage tendency information;
presenting an inquiry to the candidate driver regarding an intention to share the vehicle with the rider;
determining a driver who is to share the vehicle with the rider based on a response to the inquiry; and
extracting the candidate driver using information on a response time when the users responded to the inquiry in a past, wherein the usage tendency information includes information on the response time.
